(19) United States
(12) Patent Application Publication
(10) Pub. No.: US 2017/0036538 A1
(43) Pub. Date: Feb. 9, 2017

(54) HIGH-SPEED ROTATION VEHICLE TRANSFER

(71) Applicant: Toyota Jidosha Kabushiki Kaisha, Toyota-shi Aichi-ken (JP)

(72) Inventor: Mizuki Imafuku, Kariya-shi Aichi-ken (JP)

(21) Appl. No.: 15/226,063

(22) Filed: Aug. 2, 2016

(30) Foreign Application Priority Data
Aug. 4, 2015 (JP) 2015-154617

(51) Int. Cl. B60K 17/346; F16D 13/74; F16H 37/06; F16D 13/52; F16H 61/32; F16H 57/04

(52) U.S. Cl. CPC B60K 17/3467; F16H 61/32; F16H 57/0497; F16H 57/043; F16H 37/065; F16D 13/52; F16D 13/74; F16H 2061/2884

(57) ABSTRACT

A vehicle transfer includes an input rotating member, a first output rotating member, a second output rotating member, a high-low switching mechanism, a clutch, an oil passage, and a lubricating sleeve. The first output rotating member is configured to output power to first left and right wheels. The second output rotating member is configured to output power to second left and right wheels. The lubricating sleeve is arranged in an axial oil passage of the oil passage. The lubricating sleeve is configured to move inside the axial oil passage in conjunction with a linear motion of a screw mechanism. The lubricating sleeve is configured to switch a communication state of the axial oil passage and a plurality of radial oil passages according to a position of the lubricating sleeve, such that amounts of the lubricating oil supplied to the high-low switching mechanism and the clutch are adjusted.

### CROSS-REFERENCE TO RELATED APPLICATIONS

This application claims priority to Japanese Patent Application No. 2015-154617 filed on Aug. 4, 2015, the entire contents of which is incorporated herein by reference in its entirety including the specification, drawings and abstract.

### BACKGROUND

1. Technical Field

The present disclosure relates to a vehicle transfer, and more particularly, to a lubricating oil supplying mechanism provided in a transfer.

2. Description of Related Art

A four-wheel drive vehicle provided with a transfer that distributes power transmitted from an input rotating member to front wheels and rear wheels is well known. The FR-based four-wheel drive vehicle described in Japanese Patent Application Publication No. 2009-197955 (JP 2009-197955 A) is one such vehicle. A driving force transmitting apparatus (a transfer) described in JP 2009-197955 A includes a multiple disc clutch mechanism (a wet type multiple disc clutch) for distributing power transmitted from an input shaft to a rear-wheel output shaft and a front-wheel output shaft. Power to the rear-wheel output shaft and the front-wheel output shaft is appropriately distributed by adjusting the torque capacity of the multiple disc clutch mechanism. Also described is technology that inhibits drag that occurs in the multiple disc clutch mechanism by reducing the amount of lubricating oil supplied to the multiple disc clutch mechanism, when in two-wheel drive (2WD) in which the multiple disc clutch mechanism is released and power transmission to the front-wheel output shaft 118 is interrupted.

### SUMMARY OF THE INVENTION

A transfer provided in a four-wheel drive vehicle such as that described in JP 2009-197955 A, which includes a high-low switching mechanism that changes the rate of rotation input from an output shaft of a transmission arranged on the upstream side (the engine side) of the transfer, has been proposed. In a transfer provided with such a high-low switching mechanism, it is possible to switch between a plurality of running modes, e.g., a four-wheel drive (4WD) running mode in which the high-low switching mechanism is switched to a high-speed rotation, and a four-wheel drive (4WD) running mode in which the high-low switching mechanism is switched to a low-speed rotation, by combining the speeds from the high-low switching mechanism, instead of just a two-wheel drive (2WD) running mode and a four-wheel drive (4WD) running mode.

Also, in a transfer provided with this high-low switching mechanism, lubrication is necessary for not only the wet type multiple disc clutch, but also the high-low switching mechanism. The amounts of lubricating oil required for the wet type multiple disc clutch and the high-low switching mechanism are different for each running mode, and if this is not taken into account, the size of the oil pump will be determined by the sum of the maximum value of the amount of lubricating oil required for the wet type multiple disc clutch in each running mode, and the maximum value of the amount of lubricating oil for the high-low switching mechanism in each running mode, so the oil pump may be large.

The present disclosure thus provides a vehicle transfer provided with a wet type clutch and a high-low switching mechanism, which is able to inhibit an increase in the size of the oil pump by providing the optimum amounts of lubricating oil to the clutch and the high-low switching mechanism.

One aspect of the present disclosure relates to a vehicle transfer that includes an input rotating member, a first output rotating member, a second output rotating member, a high-low switching mechanism, a clutch, an oil pump, an oil passage, a transmitting mechanism, and a lubricating sleeve. The input rotating member is configured to rotate around an axis. The first output rotating member is configured to output power to first left and right wheels of the vehicle. The second output rotating member is configured to output power to second left and right wheels of the vehicle. The high-low switching mechanism is configured to change a rate of rotation input from the input rotating member and transmit a resultant rotation to the first output rotating member. The clutch is configured to transmit a portion of torque from the first output rotating member to the second output rotating member. The clutch is a wet type clutch. The oil pump is configured to supply lubricating oil to the high-low switching mechanism and the clutch. The oil passage is formed in the first output rotating member. The oil passage includes an axial oil passage that extends in an axial direction of the first output rotating member and a plurality of radial oil passages that extend in a radial direction of the first output rotating member, such that lubricating oil delivered from the oil pump is supplied to the high-low switching mechanism and the clutch. The transmitting mechanism includes an electric motor, and a screw mechanism that converts rotational motion of the electric motor to linear motion. The transmitting mechanism is configured to transmit the linear motion of the screw mechanism to both the high-low switching mechanism and the clutch. The lubricating sleeve is arranged in the axial oil passage. The lubricating sleeve is configured to move inside the axial oil passage in conjunction with the linear motion of the screw mechanism. The lubricating sleeve is configured to switch a communication state of the axial oil passage and the plurality of radial oil passages according to a position of the lubricating sleeve inside the axial oil passage, such that amounts of the lubricating oil supplied to the high-low switching mechanism and the clutch are adjusted.

With the vehicle transfer according to this aspect, the communication state of the axial oil passage and the radial oil passages is switched according to the position of the lubricating sleeve, such that the amounts of lubricating oil supplied to the high-low switching mechanism and the wet clutch are adjusted, by moving the lubricating sleeve inside the axial oil passage. Also, the lubricating sleeve moves in conjunction with the screw mechanism, so the amounts of lubricating oil supplied to the high-low switching mechanism and the clutch are able to be adjusted according to the operating states of the high-low switching mechanism and the clutch. In this way, because the amounts of lubricating oil supplied to the high-low switching mechanism and the clutch are able to be adjusted according to the operating states of the high-low switching mechanism and the clutch, the size of the oil pump is able to be smaller than when the amounts of lubricating oil supplied to the high-low switching mechanism and the clutch are unable to be adjusted.

In the vehicle transfer according to the aspect described above, the lubricating sleeve may be configured to adjust the number of the plurality of radial oil passages that are communicated with the axial oil passage, according to the position of the lubricating sleeve inside the axial oil passage. The lubricating sleeve may be configured to adjust a communicating area of the axial oil passage and the radial oil passages, according to the position of the lubricating sleeve inside the axial oil passage.

With the vehicle transfer according to this aspect, the number of radial oil passages communicated with the axial oil passage is adjusted, or the communicating area of the axial oil passage and the radial oil passages is adjusted, according to the position of the lubricating sleeve, so the amounts of lubricating oil supplied to the high-low switching mechanism and the clutch are able to be adjusted.

In the vehicle transfer according to the aspect described above, the high-low switching mechanism may include a planetary gear set. The high-low switching mechanism may be configured to switch to one of a high-speed rotation and a low-speed rotation. The high-low switching mechanism may be configured such that the planetary gear set rotates idly when the high-low switching mechanism is switched to the high-speed rotation. The high-low switching mechanism may be configured such that torque is transmitted to the planetary gear set when the high-low switching mechanism is switched to the low-speed rotation. The transmitting mechanism may be configured to transmit the linear motion of the screw mechanism to the high-low switching mechanism and the clutch such that the high-low switching mechanism and the clutch switch to at least three running modes including a two-wheel drive running mode, a first four-wheel drive running mode, and a second four-wheel drive running mode. In the two-wheel drive running mode, the high-low switching mechanism may be switched to the high-speed rotation and the clutch may be released. In the first four-wheel drive running mode, the high-low switching mechanism may be switched to the high-speed rotation and transfer torque of the clutch may be adjusted. In the second four-wheel drive running mode, the high-low switching mechanism may be switched to the low-speed rotation and torque from the input rotating member may be transmitted to the second output rotating member. The lubricating sleeve may be configured to switch the communication state of the axial oil passage and the plurality of radial oil passages according to the position of the lubricating sleeve inside the axial oil passage, such that in the first four-wheel drive running mode, the amount of lubricating oil supplied to the clutch increases, and in the second four-wheel drive running mode, the amount of lubricating oil supplied to the high-low switching mechanism increases.

With the vehicle transfer according to this aspect, in the first four-wheel drive running mode, the transfer torque of the wet clutch is adjusted, so the amount of lubricating oil required by the clutch increases, and in response to this, the amount of lubricating oil supplied to the clutch increases, such that the clutch is suitably lubricated. Also, in the second four-wheel drive running mode, torque is transmitted to the planetary gear set, so the amount of lubricating oil required by the high-low switching mechanism increases, and in response to this, the amount of lubricating oil supplied to the high-low switching mechanism increases, such that the high-low switching mechanism is suitably lubricated.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view schematically showing the structure of a vehicle to which the present disclosure has been applied, and illustrates the main portions of a control system for various controls in the vehicle;

FIG. 2 is a sectional view schematically showing the structure of a transfer, and illustrates the manner for switching to a four-wheel drive running state in a high-speed gear;

FIG. 3 is a skeleton view schematically showing the structure of the transfer;

FIG. 4 is a view of a lubricating structure of the transfer in FIG. 2;

FIG. 5 is a view illustrating the operating states and required lubricating oil amounts of a high-low switching mechanism and a front-wheel drive clutch in each running mode of the vehicle;

FIG. 6 is a view of the structure of a lubricating sleeve provided inside an axial oil passage;

FIG. 7 is a view illustrating the relative positions in the axial direction of a high-low switching lubrication hole and a clutch lubrication hole, and radial oil passages, for each running mode; and

FIG. 8 is a portion of a sectional view of a transfer according to another example embodiment of the present disclosure, and also a view illustrating the relative positions in the axial direction of a high-low switching lubrication hole and a clutch lubrication hole, and radial oil passages, for each running mode.

### DETAILED DESCRIPTION OF EMBODIMENTS

Hereinafter, example embodiments of the present disclosure will be described with reference to the accompanying drawings. The drawings described in the example embodiments below have been simplified or modified as appropriate, so the scale ratios and the shapes and the like of the portions are not always accurately depicted.

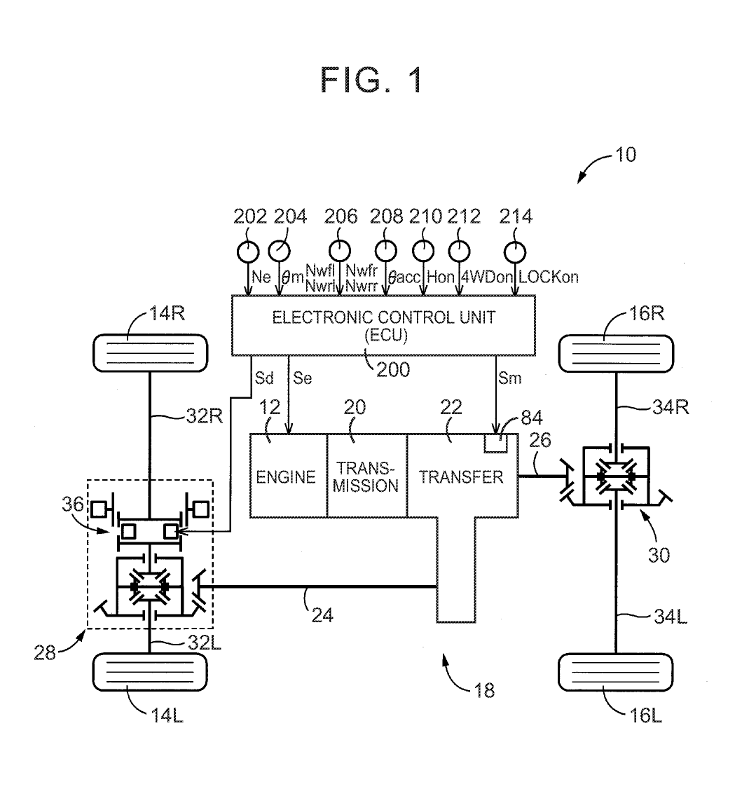

FIG. 1 is a view schematically showing the structure of a vehicle 10 to which the present disclosure has been applied, and illustrates the main portions of a control system for various controls in the vehicle 10. As shown in FIG. 1, the vehicle 10 includes an engine 12 as a driving force source, left and right front wheels 14L and 14R (simply referred to as “front wheels 14” unless otherwise specified), left and right rear wheels 16L and 16R (simply referred to as “rear wheels 16” unless otherwise specified), and a power transmitting apparatus 18 that transmits power from the engine 12 to the front wheels 14 and the rear wheels 16, and the like. The rear wheels 16 are main driving wheels that are driving wheels both when running in two-wheel drive (2WD) and in four-wheel drive (4WD). The front wheels 14 are auxiliary driving wheels that are driven wheels when running in 2WD and are driving wheels when running in 4WD. Therefore, the vehicle 10 is a front engine rear wheel drive (FR)-based four-wheel drive vehicle. The front wheels 14 correspond to second left and right wheels of the present disclosure, and the rear wheels 16 correspond to first left and right wheels of the present disclosure.

The power transmitting apparatus 18 includes a transmission 20, a vehicle transfer 22 (hereinafter, simply referred to as “transfer 22”), a front propeller shaft 24, a rear propeller shaft 26, a front wheel differential gear unit 28, a rear wheel differential gear unit 30, left and right front wheel axles 32L and 32R (simply referred to as “front wheel axles 32” unless otherwise specified), and left and right rear wheel axles 34L and 34R (simply referred to as “rear wheel axles 34” unless otherwise specified), and the like. The transmission 20 is connected to the engine 12. The transfer 22 is a front-rear wheel power transfer that is connected to the transmission 20. The front propeller shaft 24 and the rear propeller shaft 26 are both connected to the transfer 22. The front wheel differential gear unit 28 is connected to the front propeller shaft 24. The rear wheel differential gear unit 30 is connected to the rear propeller shaft 26. The front wheel axles 32 are connected to the front wheel differential gear unit 28. The rear wheel axles 34 are connected to the rear wheel differential gear unit 30. In the power transmitting apparatus 18 structured in this way, power from the engine 12 that has been transmitted to the transfer 22 via the transmission 20 is then transmitted from the transfer 22 to the rear wheels 16 via a power transmitting path on the rear wheel side that includes the rear propeller shaft 26, the rear wheel differential gear unit 30, and the rear wheel axles 34 and the like in this order. Also, some of the power from the engine 12 that is to be transmitted to the rear wheel 16 side is distributed to the front wheel 14 side by the transfer 22, and then transmitted to the front wheels 14 via a power transmitting path on the front wheel side that includes the front propeller shaft 24, the front wheel differential gear unit 28, and the front wheel axles 32 and the like in this order.

The front wheel differential gear unit 28 includes a front-side clutch 36 on the front wheel axle 32R side (i.e., between the front wheel differential gear unit 28 and the front wheel 14R). The front-side clutch 36 is a dog clutch (i.e., a mesh-type clutch) that is electrically (electromagnetically) controlled and selectively establishes or interrupts the power transmitting path between the front wheel differential gear unit 28 and the front wheel 14R. The front-side clutch 36 may also be provided with a synchronizing mechanism (synchro mechanism).

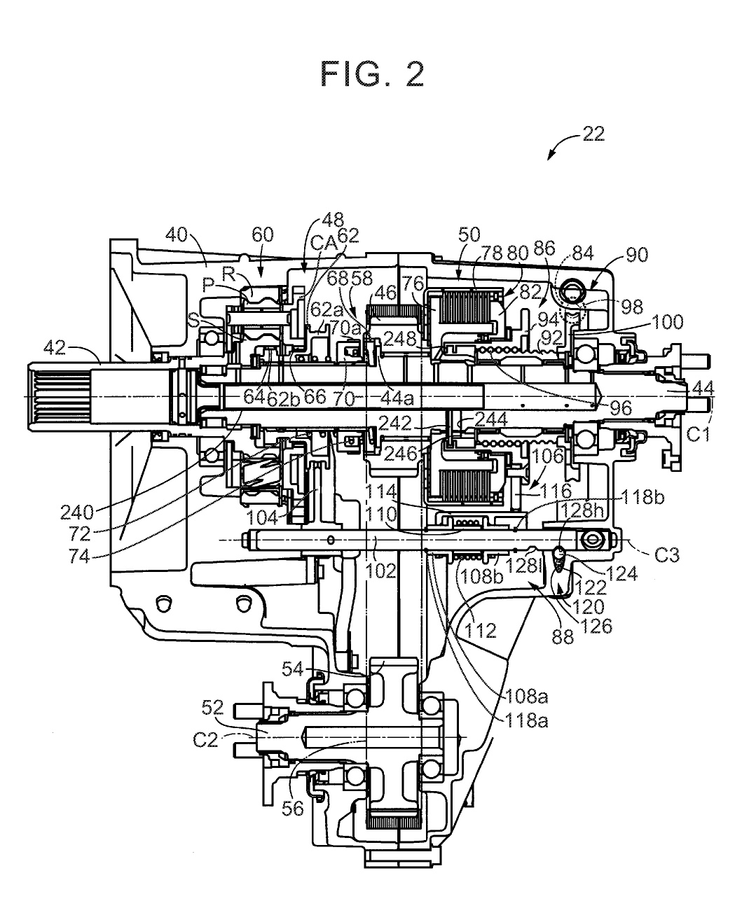

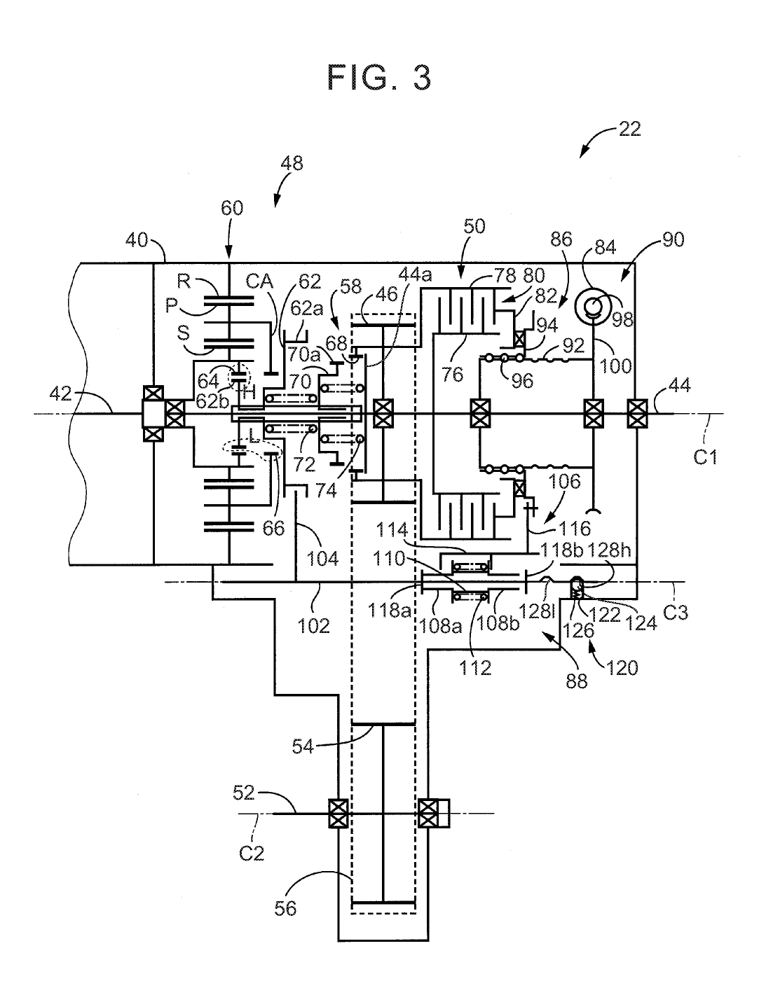

FIGS. 2 and 3 are views schematically showing the structure of the transfer 22. FIG. 2 is a sectional view of the transfer 22, and FIG. 3 is a skeleton view of the transfer 22. As shown in FIGS. 2 and 3, the transfer 22 includes a transfer case 40 as a non-rotating member. The transfer 22 includes, inside the transfer case 40 and all around a common axis C1, an input shaft 42 as an input rotating member, a rear-wheel side output shaft 44 as a first output rotating member that outputs power to the rear wheels 16, a drive gear 46 as a second output rotating member that outputs power to the front wheels 14, a high-low switching mechanism 48 as an auxiliary transmission that changes the rate of rotation input from the input shaft 42 and transmits the resultant rotation to the rear-wheel side output shaft 44, and a front-wheel drive clutch 50 as a wet type multiple disc clutch that transmits some of the torque from the rear-wheel side output shaft 44 to the drive gear 46. Also, the transfer 22 includes, inside the transfer case 40 and around a common axis C2, a front-wheel side output shaft 52, and a driven gear 54 integrally provided on the front-wheel side output shaft 52. The transfer 22 also includes, inside the transfer case 40, a front-wheel drive chain 56 that connects the drive gear 46 to the driven gear 54, and a differential locking mechanism 58 as a dog clutch that integrally connects (i.e., locks) the rear-wheel side output shaft 44 to the drive gear 46. The input shaft 42 corresponds to the input rotating member of the present disclosure, the rear-wheel side output shaft 44 corresponds to the first output rotating member of the present disclosure, the drive gear 46 corresponds to the second output rotating member of the present disclosure, and the front-wheel drive clutch 50 corresponds to the wet type multiple disc clutch of the present disclosure.

The input shaft 42 is connected to an output rotating member, not shown, of the transmission 20, via a spline engagement coupling or the like, and is rotatably driven by driving force (torque) input from the engine 12 via the transmission 20. The rear-wheel side output shaft 44 is a main drive shaft that is connected to the rear propeller shaft 26. The drive gear 46 is provided on the rear-wheel side output shaft 44 in a manner so as to be able to rotate relative to the rear-wheel side output shaft 44. The front-wheel side output shaft 52 is an auxiliary drive shaft that is connected to the front propeller shaft 24.

The transfer 22 structured in this way adjusts the torque transmitted to the drive gear 46, and transmits the power transmitted from the transmission 20 to only the rear wheels 16, or to the front wheels 14 as well, for example. Also, the transfer 22 switches between a differential state (a so-called center differential unlocked state) that allows differential rotation between the rear propeller shaft 26 and the front propeller shaft 24, and a non-differential state (a so-called center differential locked state) that prevents differential rotation between these, for example. Also, the transfer 22 establishes one of a high-speed gear (a high-speed rotation) H and a low-speed gear (a low-speed rotation) L, and changes the rate of rotation input from the transmission 20 and transmits the resultant rotation downstream, for example. That is, the transfer 22 transmits the rotation of the input shaft 42 to the rear-wheel side output shaft 44 via the high-low switching mechanism 48. Also, when transfer torque through the front-wheel drive clutch 50 is zero and the differential locking mechanism 58 is released, power is not transmitted from the rear-wheel side output shaft 44 to the front-wheel side output shaft 52. On the other hand, when torque is transmitted through the front-wheel drive clutch 50 or the differential locking mechanism 58 is engaged, power is transmitted from the rear-wheel side output shaft 44 to the front-wheel side output shaft 52 via the drive gear 46, the front-wheel drive chain 56, and the driven gear 54.

The high-low switching mechanism 48 includes a single pinion planetary gear set 60 and a high-low sleeve 62. The planetary gear set 60 includes a sun gear S that is connected to the input shaft 42 and is able to rotate around the axis C1, a ring gear R that is arranged centered around the axis C1 on the outer peripheral side of the sun gear S and that is connected to the transfer case 40 that is a non-rotatable member, in a state unable to rotate around the axis C1, and a carrier CA that rotatably supports a plurality of pinion gears P that are in mesh with the sun gear S and the ring gear R, in a manner that enables the pinion gears P to revolve around the axis C1. Accordingly, the rotation speed of the sun gear S is the same as that of the input shaft 42, and the rotation speed of the carrier CA is slower than that of the input shaft 42. High-side gear teeth 64 are fixed on an inner peripheral surface of this sun gear S, and low-side gear teeth 66 of the same diameter as the high-side gear teeth 64 are fixed on the carrier CA. The high-side gear teeth 64 are spline teeth that output rotation at the same speed as the input shaft 42 and are involved with establishing the high-speed gear H. The low-side gear teeth 66 are spline teeth that output rotation at a slower speed than the high-side gear teeth 64 and are involved with establishing the low-speed gear L.

The high-low sleeve 62 is spline engaged with the rear-wheel side output shaft 44 in a manner able to move relative to the rear-wheel side output shaft 44 in a direction parallel to the axis C1. The high-low sleeve 62 has a fork connecting portion 62a, and outer peripheral teeth 62b that are integrally provided adjacent to the fork connecting portion 62a and mesh with the high-side gear teeth 64 and the low-side gear teeth 66 by the high-low sleeve 62 moving in the direction parallel to the axis C1 of the rear-wheel side output shaft 44. Rotation at the same speed as the rotation of the input shaft 42 is transmitted to the rear-wheel side output shaft 44 when the outer peripheral teeth 62b are in mesh with the high-side gear teeth 64, and rotation at a slower speed than the rotation of the input shaft 42 is transmitted to the rear-wheel side output shaft 44 when the outer peripheral teeth 62b are in mesh with the low-side gear teeth 66. The high-side gear teeth 64 and the high-low sleeve 62 function as a high-speed rotation clutch for establishing a high-speed rotation H (a high-speed gear H), and the low-side gear teeth 66 and the high-low sleeve 62 function as a low-speed rotation clutch for establishing a low-speed rotation L (a low-speed gear L). The high-low switching mechanism 48 is in a power transmission interrupted state (i.e., a neutral state) when the high-low sleeve 62 is not in mesh with either the high-side gear teeth 64 or the low-side gear teeth 66. The high-low switching mechanism 48 passes through this power transmission interrupted state when switching gears between the high-speed gear H and the low-speed gear L.

The differential locking mechanism 58 has locking teeth 68 fixed on an inner peripheral surface of the drive gear 46, and a locking sleeve 70 that is splined engaged with the rear-wheel side output shaft 44 so as to be able to move in the direction parallel to the axis C1 relative to the rear-wheel side output shaft 44, and that has, fixed to an outer peripheral surface thereof, outer peripheral teeth 70a that mesh with the locking teeth 68 when the locking sleeve 70 moves in the direction parallel to the axis C1. In the transfer 22, when the differential locking mechanism 58 is in an engaged state in which the outer peripheral teeth 70a of the locking sleeve 70 are in mesh with the locking teeth 68, the rear-wheel side output shaft 44 and the drive gear 46 rotate together as a unit, such that the center differential locked state is established.

The high-low sleeve 62 is provided in a space between the planetary gear set 60 and the drive gear 46 in the axial direction of the rear-wheel side output shaft 44 (hereinafter, the axial direction will be referred to as the “axial direction of the rear-wheel side output shaft 44” unless otherwise specified). The locking sleeve 70 is provided adjacent to the high-low sleeve 62, in the space between the high-low switching mechanism 48 and the drive gear 46 in the axial direction. The transfer 22 is provided with a first spring 72 between the high-low sleeve 62 and the locking sleeve 70. This first spring 72 is abutted against the high-low sleeve 62 and locking sleeve 70, and urges the high-low sleeve 62 and the locking sleeve 70 away from each other. The transfer 22 is also provided with a second spring 74 between the drive gear 46 and the locking sleeve 70. This second spring 74 is abutted against a protruding portion 44a of the rear-wheel side output shaft 44 and the locking sleeve 70, and urges the locking sleeve 70 toward the side away from the locking teeth 68. The protruding portion 44a is a flange portion of the rear-wheel side output shaft 44 that is provided protruding toward the radial outside in a space formed on the radially inner side of the drive gear 46. The high-side gear teeth 64 are provided in a position farther away from the locking sleeve 70 than the low-side gear teeth 66 when viewed from the radial direction. The outer peripheral teeth 62b of the high-low sleeve 62 mesh with the high-side gear teeth 64 on the side where the high-low sleeve 62 moves away from the locking sleeve 70 in the axial direction (i.e., on the left side in FIGS. 2 and 3), and mesh with the low-side gear teeth 66 on the side where the high-low sleeve 62 moves toward the locking sleeve 70 in the axial direction (i.e., on the right side in FIGS. 2 and 3). The outer peripheral teeth 70a of the locking sleeve 70 mesh with the locking teeth 68 on the side where the locking sleeve 70 moves toward the drive gear 46 in the axial direction (i.e., on the right side in FIGS. 2 and 3). Therefore, the outer peripheral teeth 70a of the locking sleeve 70 mesh with the locking teeth 68 when the high-low sleeve 62 is in the position in which the outer peripheral teeth 62b of the high-low sleeve 62 are in mesh with the low-side gear teeth 66.

The front-wheel drive clutch 50 is a wet type multiple disc friction clutch that includes a clutch hub 76 that is connected to the rear-wheel side output shaft 44 in a manner unable to rotate relative to the rear-wheel side output shaft 44, a clutch drum 78 that is connected to the drive gear 46 in a manner unable to rotate relative to the drive gear 46, a friction engagement element 80 that is interposed between the clutch hub 76 and the clutch drum 78 and selectively engages and disengages the clutch hub 76 and the clutch drum 78, and a piston 82 that presses on the friction engagement element 80. The front-wheel drive clutch 50 is arranged on the opposite side of the drive gear 46 with respect to the high-low switching mechanism 48 in the axial direction of the rear-wheel side output shaft 44. The front-wheel drive clutch 50 is placed in a released state when the piston 82 is moved toward the non-pressing side (i.e., the right side in FIGS. 2 and 3) that is the side away from the friction engagement element 80 in the axial direction, and is not abutting against the friction engagement element 80. On the other hand, the front-wheel drive clutch 50 is placed in a slip state or an engaged state (a firmly connected state) by the transfer torque (torque capacity) being adjusted by the amount of movement of the piston 82, when the piston 82 is moved toward the pressing side (i.e., the left side in FIGS. 2 and 3) that is the side closer to the drive gear 46 in the axial direction, and is abutting against the friction engagement element 80.

When the front-wheel drive clutch 50 is in the released state and the differential locking mechanism 58 is in a released state in which the outer peripheral teeth 70a of the locking sleeve 70 are not in mesh with the locking teeth 68, the power transmitting path between the rear-wheel side output shaft 44 and the drive gear 46 is interrupted such that the transfer 22 transmits the power transmitted from the transmission 20 to only the rear wheels 16. When the front-wheel drive clutch 50 is in the slip state or the engaged state, the transfer 22 distributes the power transmitted from the transmission 20 to both the front wheels 14 and the rear wheels 16. When the front-wheel drive clutch 50 is in the slip state, differential rotation is allowed between the rear-wheel side output shaft 44 and the drive gear 46, such that the differential state (the center differential unlocked state) is established in the transfer 22. When the front-wheel drive clutch 50 is in the engaged state, the rear-wheel side output shaft 44 and the drive gear 46 rotate together as a unit, such that the center differential locked state is established in the transfer 22. The front-wheel drive clutch 50 is able to continuously change the torque distribution between the front wheels 14 and the rear wheels 16 between 0:100 and 50:50, for example, by controlling the transfer torque.

The transfer 22 also includes, as an apparatus that operates the high-low switching mechanism 48, the front-wheel drive clutch 50, and the differential locking mechanism 58, an electric motor 84, a screw mechanism 86 that converts the rotational motion of the electric motor 84 into linear motion, and a transmitting mechanism 88 that transmits the linear motion of the screw mechanism 86 to the high-low switching mechanism 48, the front-wheel drive clutch 50, and the differential locking mechanism 58.

The screw mechanism 86 is arranged around the same axis C1 as the rear-wheel side output shaft 44, and includes a threaded shaft member 92 as a rotating member that is indirectly connected to the electric motor 84 via a worm gear 90 provided in the transfer 22, and a nut member 94 as a linear motion member that is connected to the threaded shaft member 92 so as to be able to move in the axial direction (the direction parallel to the axis C1) as the threaded shaft member 92 rotates. The screw mechanism 86 is a ball screw in which the threaded shaft member 92 and the nut member 94 operate via multiple balls 96. The worm gear 90 is a gear pair that includes a worm 98 integrally formed on an electric motor shaft of the electric motor 84, and a worm wheel 100 that is arranged around the axis C1 and integrally formed on the threaded shaft member 92. For example, the rotation from the electric motor 84 that is a brushless motor is reduced in speed and transmitted to the threaded shaft member 92 via the worm gear 90. The screw mechanism 86 converts the rotation of the electric motor 84 transmitted to the threaded shaft member 92 into linear motion of the nut member 94.

The transmitting mechanism 88 includes a fork shaft 102 that is provided around a different axis C3 that is parallel to the axis C1 of the threaded shaft member 92 and is connected to the nut member 94, and a fork 104 that is fixed on the fork shaft 102 and is connected to the high-low sleeve 62. The transmitting mechanism 88 transmits the linear motion force of the nut member 94 of the screw mechanism 86 to the high-low sleeve 62 of the high-low switching mechanism 48 via the fork shaft 102 and the fork 104. Force is applied to both the high-low sleeve 62 and the locking sleeve 70 via the first spring 72, and the locking sleeve 70 receives force from the protruding portion 44a of the rear-wheel side output shaft 44 via the second spring 74. Accordingly, the transmitting mechanism 88 transmits the linear motion force of the nut member 94 of the screw mechanism 86 to the locking sleeve 70 of the differential locking mechanism 58 via the high-low sleeve 62. Therefore, the first spring 72 and the second spring 74 function as members that form a portion of the transmitting mechanism 88.

The screw mechanism 86 is arranged on the opposite side of the front-wheel drive clutch 50 than the drive gear 46. The piston 82 of the front-wheel drive clutch 50 is connected to the nut member 94 of the screw mechanism 86 in a manner non-movable relative to the nut member 94 in the axial direction, and rotatable relative to the nut member 94 around the axis C1. Accordingly, the linear motion force of the nut member 94 of the screw mechanism 86 is transmitted to the friction engagement element 80 of the front-wheel drive clutch 50 via the piston 82. Therefore, the piston 82 is a pressing member that is connected to the nut member 94 and presses on the friction engagement element 80 of the front-wheel drive clutch 50, and functions as a member that forms a portion of the transmitting mechanism 88. In this way, the transmitting mechanism 88 transmits the linear motion force of the nut member 94 of the screw mechanism 86 to the friction engagement element 80 of the front-wheel drive clutch 50.

The transmitting mechanism 88 includes a connecting mechanism 106 that connects the nut member 94 to the fork shaft 102. The connecting mechanism 106 includes two flanged cylindrical members 108a and 108b, a cylindrical spacer 110, a third spring 112, a grasping member 114, and a connecting member 116. The two flanged cylindrical members 108a and 108b are arranged around the axis C3 and are able to slide on the fork shaft 102 in a direction parallel to the axis C3. The two flanged cylindrical members 108a and 108b are arranged such that a flange provided on one end portion of the flanged cylindrical member 108a faces a flange provided on one end portion of the flanged cylindrical member 108b. The spacer 110 is interposed between the two flanged cylindrical members 108a and 108b. The third spring 112 is arranged on the outer peripheral side of the spacer 110. The grasping member 114 grasps the two flanged cylindrical members 108a and 108b in a manner that enables the two flanged cylindrical members 108a and 108b to slide in a direction parallel to the axis C3. The connecting member 116 connects the grasping member 114 to the nut member 94. The grasping member 114 slides the flanged cylindrical members 108a and 108b on the fork shaft 102 by abutting against the flanges of the flanged cylindrical members 108a and 108b. The length between the flanges of the flanged cylindrical members 108a and 108b when the flanges are both abutted against the grasping member 114 is longer than the length of the spacer 110. Therefore, the state in which the flanges are both abutted against the grasping member 114 is created by the urging force of the third spring 112.

The fork shaft 102 has stoppers 118a and 118b on an outer peripheral surface. These stoppers 118a and 118b stop the flanged cylindrical members 108a and 108b, respectively, from sliding in the direction parallel to the axis C3. Stopping the flanged cylindrical members 108a and 108b from sliding with the stoppers 118a and 118b in this way enables the transmitting mechanism 88 to transmit the linear motion force of the nut member 94 to the high-low switching mechanism 48 via the fork shaft 102 and the fork 104.

The outer peripheral teeth 70a of the locking sleeve 70 mesh with the locking teeth 68 when the fork shaft 102 is in a position that places the outer peripheral teeth 62b of the high-low sleeve 62 in mesh with the low-side gear teeth 66 (hereinafter, this position will be referred to as a “low gear position”). The friction engagement element 80 of the front-wheel drive clutch 50 is pressed on by the piston 82 when the fork shaft 102 is in a position that places the outer peripheral teeth 62b of the high-low sleeve 62 in mesh with the high-side gear teeth 64 (hereinafter, this position will be referred to as a “high gear position”). The friction engagement element 80 of the front-wheel drive clutch 50 is not pressed on by the piston 82 when the fork shaft 102 is in the low gear position.

When the fork shaft 102 is in the high gear position, the length between the flanges of the flanged cylindrical members 108a and 108b is able to be changed between the length when the flanges are both in a state abutted against the grasping member 114, and the length of the spacer 110. Therefore, the connecting mechanism 106 allows the nut member 94 to move in the direction parallel to the axis C1, between a position in which the friction engagement element 80 of the front-wheel drive clutch 50 is pressed on by the piston 82 and a position in which the friction engagement element 80 of the front-wheel drive clutch 50 is not pressed on by the piston 82, while the fork shaft 102 remains in the high gear position.

The transfer 22 includes a gear position maintaining mechanism 120 that maintains the high gear position of the fork shaft 102, and maintains the low gear position of the fork shaft 102. The gear position maintaining mechanism 120 includes a housing hole 122, a locking ball 124, a locking spring 126, and recessed portions 128h and 128l. The housing hole 122 is formed in an inner peripheral surface of the transfer case 40 along which the fork shaft 102 slides. The locking ball 124 is housed in the housing hole 122. The locking spring 126 is housed in the housing hole 122 and urges the locking ball 124 toward the fork shaft 102 side. The recessed portions 128h and 128l are formed on an outer peripheral surface of the fork shaft 102. The recessed portion 128h receives a portion of the locking ball 124 when the fork shaft 102 is in the high gear position, and the recessed portion 128l receives a portion of the locking ball 124 when the fork shaft 102 is in the low gear position. By maintaining the gear position (either the high or the low gear position) of the fork shaft 102 with this gear position maintaining mechanism 120, the gear position (either the high or the low gear position) of the fork shaft 102 is able to be maintained even if output from the electric motor 84 is stopped in that gear position.

Returning now to FIG. 1, an electronic control unit (ECU) 200 that includes a control apparatus of the vehicle 10 that switches between a two-wheel drive (2WD) running state and a four-wheel drive (4WD) running state, for example, is provided in the vehicle 10. The ECU 200 includes a so-called microcomputer that includes, for example, a CPU, RAM, ROM, and an input/output interface and the like. The CPU executes various controls of the vehicle 10 by processing signals according to a program stored in advance in the ROM, while using the temporary storage function of the RAM.

For example, the ECU 200 executes output control of the engine 12, and switching control to switch the driving state of the vehicle 10, and the like, and is formed divided into sections for engine control and driving state control and the like as necessary. As shown in FIG. 1, various actual values based on detection signals from various sensors provided in the vehicle 10 are supplied to the ECU 200. Examples of such actual values include an engine speed Ne, a motor rotation angle θm, wheel speeds Nwfl, Nwfr, Nwrl, and Nwrr of the front wheels 14L and 14R and the rear wheels 16L and 16R, an accelerator operation amount θacc, an H-range request Hon that is a signal indicating that an H-range selector switch 210 has been operated, a 4WD request 4WDon that is a signal indicating that a 4WD selector switch 212 has been operated, and LOCKon that is a signal indicating that a differential lock selector switch 214 has been operated, and the like. Examples of the various sensors include an engine speed sensor 202, a motor rotation angle sensor 204, wheel speed sensors 206, an accelerator operation amount sensor 208, a H-range selector switch 210 for selecting the high-speed rotation H (the high-speed gear H) in response to an operation by the driver, the 4WD selector switch 212 for selecting the 4WD running state in response to an operation by the driver, and the differential lock selector switch 214 for selecting the center differential locked state in response to an operation by the driver, and the like.

Various signals, for example, an engine output control command signal Se for output control of the engine 12, an operation command signal Sd for switching the state of the front-side clutch 36, and a motor drive command signal Sm for controlling the rotation amount of the electric motor 84, and the like, are output from the ECU 200 to an output control apparatus of the engine 12, an actuator of the front-side clutch 36, and the electric motor 84 and the like, respectively, as shown in FIG. 1.

In the vehicle 10 structured as described above, the amount of movement (i.e., the stroke) of the nut member 94 is controlled by controlling the rotation amount of the electric motor 84. When the fork shaft 102 is in the high gear position, the position in which the front-wheel drive clutch 50 is placed in the released state by driving the electric motor 84 a predetermined rotation amount to move the nut member 94 by a predetermined stroke amount toward the non-pressing side from a position in which the piston 82 is abutted against the friction engagement element 80, is a position (referred to as an “H2 position”) that places the vehicle 10 in the 2WD running state in which only the rear wheels 16 are driven in the high-speed rotation H (the high-speed gear H). In this H2 position, the front-side clutch 36 is placed in the released state, and rotation is not transmitted from either the engine 12 side or the front wheel 14 side to the rotating elements (e.g., the drive gear 46, the front-wheel drive chain 56, the driven gear 54, the front-wheel side output shaft 52, the front propeller shaft 24, and the front wheel differential gear unit 28) that form the power transmitting path from the drive gear 46 to the front wheel differential gear unit 28, when running in 2WD. Therefore, when running in 2WD, these rotating elements are stopped from rotating and thus are prevented from being dragged along, so running resistance is reduced.

Also, for example, as shown in FIG. 2, when the fork shaft 102 is in the high gear position, the position in which the front-wheel drive clutch 50 is placed in the slip state by controlling the rotation amount of the electric motor 84 to move the nut member 94 toward the pressing side from the position where the piston 82 abuts against the friction engagement element 80, is a position (referred to as an “H4 position”) that places the vehicle 10 in the 4WD running state in which power is transmitted to both the front wheels 14 and the rear wheels 16 in the high-speed rotation H (the high-speed gear H). In this H4 position, torque distribution between the front wheels 14 and the rear wheels 16 is adjusted as necessary by controlling the transfer torque of the front-wheel drive clutch 50.

Also, for example, as shown in FIG. 2, the position in which the front-wheel drive clutch 50 is firmly connected (completely engaged) by controlling the rotation amount of the electric motor 84 to move the nut member 94 farther to the pressing side from the H4 position, is a position (referred to as a “H4L position”) for placing the vehicle 10 in the 4WD running state in the center differential locked state in the high-speed rotation H.

Also, when the fork shaft 102 is in the low gear position, the front-wheel drive clutch 50 is in the released state and the differential locking mechanism 58 is in the engaged state, i.e., the outer peripheral teeth 70a of the locking sleeve 70 are in mesh with the locking teeth 68 of the drive gear 46, so this position is a position (referred to as an “L4L position”) that places the vehicle 10 in the 4WD running state in the center differential locked state in the low-speed rotation L (the low-speed gear L).

The switch between the high gear position and the low gear position of the fork shaft 102 is performed when the transmission 20 is in neutral and the vehicle 10 is stopped. Therefore, if the phases of the locking teeth 68 and the outer peripheral teeth 70a of the locking sleeve 70 do not match in the differential locking mechanism 58, the transition between engagement and release may not be able to be smooth. With regards to such a problem, the high-low sleeve 62 is provided separately from the locking sleeve 70, so even if the locking sleeve 70 is unable to move when the fork shaft 102 is switched between the high gear position and the low gear position, the high-low sleeve 62 is able to move. Therefore, when the fork shaft 102 switches between the high gear position and the low gear position, the high-low sleeve 62 will not stop moving at the position that places the high-low switching mechanism 48 in neutral, so at the very least power transfer to the rear wheel 16 side is ensured.

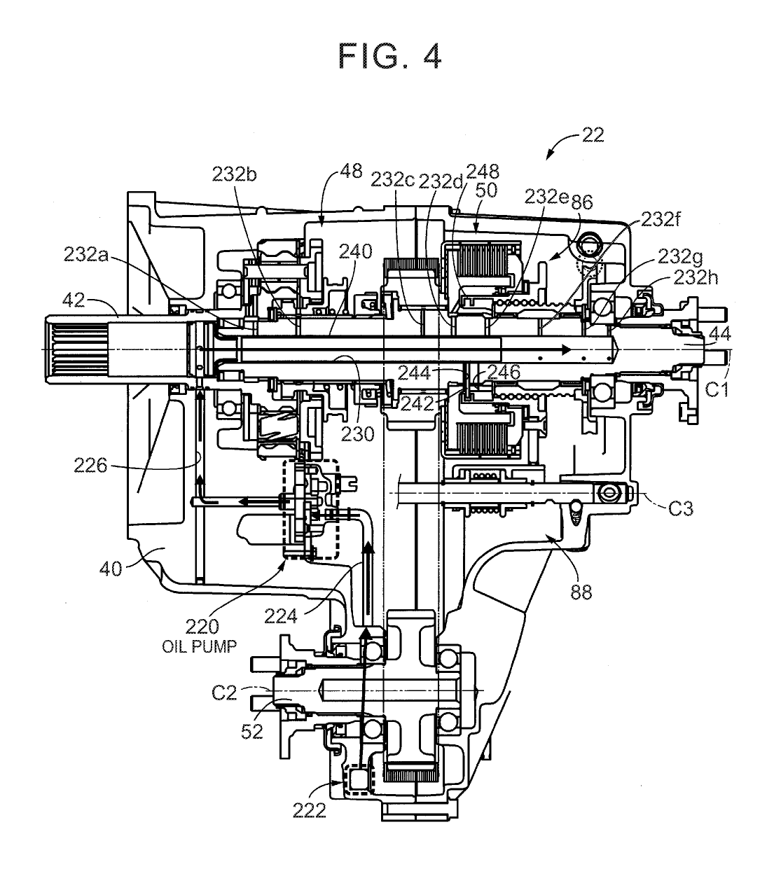

FIG. 4 is a sectional view of the lubrication structure of the transfer 22. The sectional view in FIG. 4 shows a cross-section of an oil pump 220 and an oil passage 226, described later, for supplying lubricating oil to the high-low switching mechanism 48 and the front-wheel drive clutch 50. That is, a lubricating structure formed by the oil pump 220 and the like is provided in a position that is different from the position where the transmitting mechanism 88 (the fork shaft 102 and the like) is provided in the circumferential direction, on the outer peripheral side of the rear-wheel side output shaft 44. Also, the arrow in FIG. 4 indicates the supply path of the lubricating oil.

As shown in FIG. 4, the transfer 22 includes the oil pump 220. The oil pump 220 draws up lubricating oil through a pipe 224 from a strainer 222, and delivers the lubricating oil to the oil passage 226 formed in the transfer case 40. The lubricating oil delivered to the oil passage 226 is supplied to an axial oil passage 230 that is parallel to the axis C1 and formed in the rear-wheel side output shaft 44.

Also, a plurality of radial oil passages 232a to 232h that are communicated with the axial oil passage 230 are formed in the rear-wheel side output shaft 44. The radial oil passages 232a to 232h communicate a peripheral wall surface of the axial oil passage 230 with an outer peripheral surface of the rear-wheel side output shaft 44. Also, each of the radial oil passages 232a to 232h is formed near a portion arranged to the radial outside of the rear-wheel side output shaft 44, which requires lubrication. For example, the radial oil passages 232a and 232b are formed in positions overlapping with the high-low switching mechanism 48 when viewed from the radial direction, and the radial oil passages 232d and 232e are formed in positions overlapping with the front-wheel drive clutch 50 when viewed from the radial direction. In this way, lubricating oil is efficiently supplied to portions where it is needed, by the radial oil passages 232a to 232h being formed near portions that require lubrication. Therefore, the axial oil passage 230 and the radial oil passages 232a to 232h function as oil passages for supplying lubricating oil delivered from the oil pump 220 to the high-low switching mechanism 48 and the front-wheel drive clutch 50.

The transfer 22 is configured to be able to switch between a plurality of running modes according to the switching state of the high-low switching mechanism 48 and the engagement state of the front-wheel drive clutch 50. The amounts of lubricating oil (lubricating oil amounts) required by the high-low switching mechanism 48 and the front-wheel drive clutch 50 also change according to the plurality of running modes.

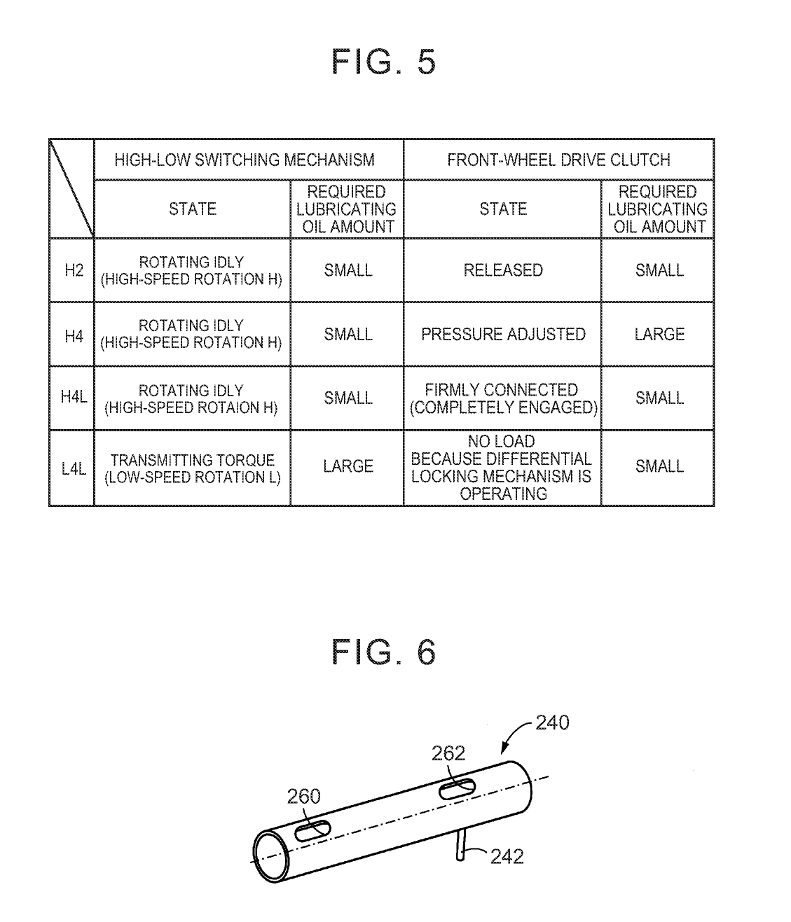

FIG. 5 is a chart illustrating the operating states, as well as the required lubricating oil amounts, of the high-low switching mechanism 48 and the front-wheel drive clutch 50 in each running mode. H2 shown in FIG. 5 corresponds to the H2 position described above, and corresponds to a 2WD running mode in which the high-low switching mechanism 48 is switched to the high-speed rotation H and the front-wheel drive clutch 50 is released. At this time, in the high-low switching mechanism 48, the sun gear S that is connected to the input shaft 42 is connected to the rear-wheel side output shaft 44 via the high-low sleeve 62, and the other rotating elements (the carrier CA and the like) of the planetary gear set 60 that forms the high-low switching mechanism 48 rotate idly so torque will not be transmitted to the planetary gear set 60. Therefore, the lubricating oil amount required by the planetary gear set 60 (i.e., the required lubricating oil amount) is less. Also, the front-wheel drive clutch 50 is released, so the lubricating oil amount required by the front-wheel drive clutch 50 (i.e., the required lubricating oil amount) is also less. The running mode corresponding to H2 corresponds to the two-wheel drive running mode of the present disclosure.

H4 shown in FIG. 5 corresponds to the H4 position described above, and corresponds to a 4WD running mode in which the high-low switching mechanism 48 is switched to the high-speed rotation H, and the transfer torque of the front-wheel drive clutch 50 is adjusted. At this time, the planetary gear set 60 of the high-low switching mechanism 48 rotates idly, so the required lubricating oil amount of the high-low switching mechanism 48 is less. Also, in the front-wheel drive clutch 50, the pressing force of the piston 82 is adjusted, i.e., the transfer torque is adjusted, so the required lubricating oil amount of the front-wheel drive clutch 50 is greater. The running mode corresponding to the H4 corresponds to the first four-wheel drive running mode of the present disclosure.

H4L shown in FIG. 5 corresponds to the H4L position described above, and corresponds to a 4WD running mode in which the high-low switching mechanism 48 is switched to the high-speed rotation H, and the front-wheel drive clutch 50 is firmly connected (completely engaged). At this time, the planetary gear set 60 of the high-low switching mechanism 48 rotates idly, so the required lubricating oil amount of the high-low switching mechanism 48 is less. Also, in the front-wheel drive clutch 50, the clutch hub 76 and the clutch drum 78 rotate together as a unit, so no sliding occurs in the friction engagement element 80, and thus the required lubricating oil amount of the front-wheel drive clutch 50 is less.

L4L shown in FIG. 5 corresponds to the L4L position described above, and corresponds to a 4WD running mode in which the high-low switching mechanism 48 is switched to the low-speed rotation L, and the differential locking mechanism 58 is engaged. At this time, the high-low switching mechanism 48 is in a differential state in which torque is transmitted to the planetary gear set 60. More specifically, torque input to the sun gear S is output from the carrier CA. Because torque is transmitted to the planetary gear set 60 in this way, the required lubricating oil amount of the high-low switching mechanism 48 increases. Also, torque is transmitted to the front wheels 14 via the differential locking mechanism 58 even though the front-wheel drive clutch 50 is released (i.e., there is no load on the front-wheel drive clutch 50 because the differential locking mechanism 58 is operating), so the required lubricating oil amount of the front-wheel drive clutch 50 is less. The running mode corresponding to L4L corresponds to the second four-wheel drive running mode of the present disclosure.

As described above, the lubricating oil amounts required by the high-low switching mechanism 48 and the front-wheel drive clutch 50 change according to the running mode. Also, there is no running mode in which the required lubricating oil amounts of both the high-low switching mechanism 48 and the front-wheel drive clutch 50 increase. Here, an insufficiency of lubricating oil able to be avoided by obtaining the maximum value of the required lubricating oil amount of the high-low switching mechanism 48 and the maximum value of the required lubricating oil amount of the front-wheel drive clutch 50 in all of the running modes and setting the size of the oil pump 220 such that lubricating oil of an amount equal to the sum of these is able to be delivered. However, the oil pump 220 would end up being large, so excessive amounts of lubricating oil would be supplied to the high-low switching mechanism 48 and the front-wheel drive clutch 50 even in a running mode in which only a small amount of lubricating oil is required. For example, in the 2WD running mode corresponding to H2, the front-wheel drive clutch 50 is released so the required lubricating oil amount of the front-wheel drive clutch 50 is small, but excessive lubricating oil would be supplied to the front-wheel drive clutch 50. Also, in H2, the front-side clutch 36 is released in conjunction with the front-wheel drive clutch 50 being released, so rotational power is not transmitted to the rotating elements that form the power transmitting path from the drive gear 46 to the front wheel differential gear unit 28. At this time, if the amount of lubricating oil supplied to the front-wheel drive clutch 50 is excessive, relative rotation will occur in the friction engagement element 80 of the front-wheel drive clutch 50, so drag torque due to the viscosity of the lubricating oil will occur and the rotating elements will be dragged around, which may also decrease fuel efficiency.

In contrast, a lubricating sleeve 240 that switches the communication state of the axial oil passage 230 and the radial oil passages 232a to 232h according to the running mode and adjusts the amounts of lubricating oil supplied to the high-low switching mechanism 48 and the front-wheel drive clutch 50 is provided in the axial oil passage 230. The lubricating sleeve 240 has a cylindrical shape as shown in FIG. 6, and is provided able to move along the axis C1 inside the axial oil passage 230. The lubricating oil is sealed between the lubricating sleeve 240 and the peripheral wall surface of the axial oil passage 230, and the outside diameter of the lubricating sleeve 240 is set to allow the lubricating sleeve 240 to slide inside the axial oil passage 230.

A pin 242 that protrudes from an outer peripheral surface toward the radial outside as shown in FIGS. 2 and 6 is provided on the lubricating sleeve 240. This pin 242 rotates together with the lubricating sleeve 240 around the axis C1. Also, as shown in FIGS. 2 and 4, cutouts 244 and 246 that extend elongated in the axial direction are formed in the rear-wheel side output shaft 44 and the clutch hub 76, respectively, and the pin 242 passes through these cutouts 244 and 246 in the radial direction. Also, because the cutouts 244 and 246 are both formed elongated in the axial direction, the pin 242 is able to move relative to the rear-wheel side output shaft 44 and the clutch hub 76 in the axial direction. In this context, the lubricating sleeve 240 to which the pin 242 is fixed is also able to move relative to the rear-wheel side output shaft 44 in the axial direction.

An end portion on the radial outside of the pin 242 is engaged with an engaging portion 248 that has a U-shaped cross-section and is formed on an end portion of the nut member 94 in the axial direction. This engaging portion 248 is formed in an annular shape in the circumferential direction, and has the U-shaped cross-section. Therefore, the pin 242 and the engaging portion 248 engage irrespective of the rotational position of the pin 242. According to this kind of structure, the pin 242 and the lubricating sleeve 240 move in the axial direction in conjunction with the nut member 94. Also, although not shown, the rear-wheel side output shaft 44 and the lubricating sleeve 240 are configured to not rotate relative to one another around the axis C1 by a detent.

As shown in FIG. 6, a high-low switching mechanism lubricating hole 260 and a clutch lubricating hole 262 that are formed elongated in the axial direction are formed lined up in the axial direction in the lubricating sleeve 240. The high-low switching mechanism lubricating hole 260 and the clutch lubricating hole 262 are formed on the same phase in the circumferential direction, which is a phase apart from the pin 242 in the circumferential direction, e.g., a phase 180 degrees apart from the pin 242 in the circumferential direction.

The high-low switching mechanism lubricating hole 260 is formed near the radial oil passages 232a and 232b that are formed in the rear-wheel side output shaft 44 when viewed from the radial direction, and in the same phase in the circumferential direction as these radial oil passages 232a and 232b, when the lubricating sleeve 240 is assembled to the rear-wheel side output shaft 44. The clutch lubricating hole 262 is formed near the radial oil passages 232d and 232e that are formed in the rear-wheel side output shaft 44 when viewed from the radial direction, and in the same phase in the circumferential direction as these radial oil passages 232d to 232e, when the lubricating sleeve 240 is assembled to the rear-wheel side output shaft 44.

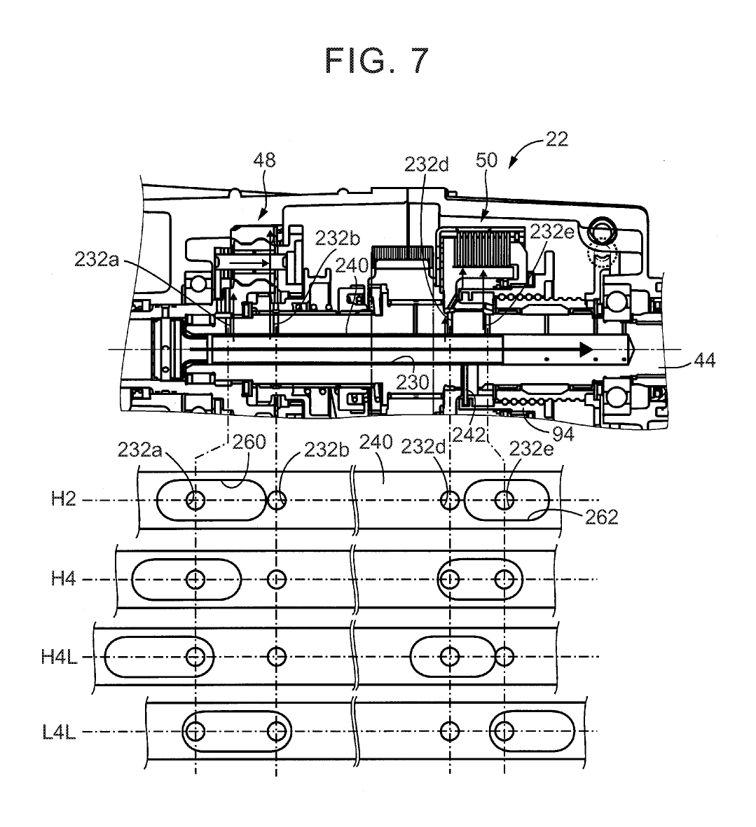

FIG. 7 is a view illustrating the relative positions in the axial direction of the high-low switching mechanism lubricating hole 260 and the clutch lubricating hole 262 in the lubricating sleeve 240, and the radial oil passages 232a, 232b, 232d, and 232e, for each running mode. The lubricating sleeve 240 is operatively linked to the nut member 94 via the pin 242, so the relative positions switch for each running mode. The radial oil passage 232c is communicated with the axial oil passage 230 irrespective of the position of the lubricating sleeve 240, by a lubricating oil hole, not shown, formed in the lubricating sleeve 240.

First, in H2 that is a 2WD running mode, the high-low switching mechanism 48 is switched to the high-speed rotation H and the front-wheel drive clutch 50 is moved to the released position, by the nut member 94. At this time, the lubricating sleeve 240 that is operatively linked to the nut member 94 is moved to a position where the high-low switching mechanism lubricating hole 260 overlaps with the radial oil passage 232a, and the clutch lubricating hole 262 overlaps with the radial oil passage 232e. That is, the lubricating sleeve 240 is moved to a position where the axial oil passage 230 is communicated with the radial oil passage 232a via the high-low switching mechanism lubricating hole 260, and the axial oil passage 230 is communicated with the radial oil passage 232e via the clutch lubricating hole 262. Therefore, lubricating oil supplied to the axial oil passage 230 is supplied to the high-low switching mechanism 48 via the radial oil passage 232a, and is also supplied to the front-wheel drive clutch 50 via the radial oil passage 232e. Because lubricating oil is supplied to the high-low switching mechanism 48 and the front-wheel drive clutch 50 from one radial oil passage 232a and 232e each in this way, the amounts of lubricating oil that are supplied to the high-low switching mechanism 48 and the front-wheel drive clutch 50 are less. This coincides with the required lubricating oil amounts of the high-low switching mechanism 48 and the front-wheel drive clutch 50 in H2 shown in FIG. 5.

Also, in H4 that is a 4WD running mode in which the high-low switching mechanism 48 is switched to the high-speed rotation H and the transfer torque of the front-wheel drive clutch 50 is adjusted, the lubricating sleeve 240 is moved farther toward the input shaft 42 side (the left side in FIG. 7) in the axial direction than the position of H2, in conjunction with the nut member 94. At this time, the lubricating sleeve 240 is moved to a position where the high-low switching mechanism lubricating hole 260 overlaps with the radial oil passage 232a, and the clutch lubricating hole 262 overlaps with the radial oil passage 232d and the radial oil passage 232e. Therefore, the lubricating oil that is supplied to the axial oil passage 230 is supplied to the high-low switching mechanism 48 via the radial oil passage 232a, and is also supplied to the front-wheel drive clutch 50 via the radial oil passages 232d and 232e. Because lubricating oil is supplied to the front-wheel drive clutch 50 from the two radial oil passages 232d and 232e, while lubricating oil is supplied to the high-low switching mechanism 48 from the single radial oil passage 232a in this way, the amount of lubricating oil that is supplied to the high-low switching mechanism 48 decreases, and the amount of lubricating oil that is supplied to the front-wheel drive clutch 50 increases. That is, the amount of lubricating oil that is supplied to the front-wheel drive clutch 50 increases compared to the running mode of H2. This coincides with the required lubricating oil amounts of the high-low switching mechanism 48 and the front-wheel drive clutch 50 in H4 shown in FIG. 5.

Also, in H4L that is a 4WD running mode in which the high-low switching mechanism 48 is switched to the high-speed rotation H and the front-wheel drive clutch 50 is firmly connected (completely engaged), the lubricating sleeve 240 is moved even farther toward the input shaft 42 side (the left side in FIG. 7) in the axial direction than the H4 position, in conjunction with the nut member 94. At this time, the lubricating sleeve 240 is moved to a position where the high-low switching mechanism lubricating hole 260 overlaps with the radial oil passage 232a, and the clutch lubricating hole 262 overlaps with the radial oil passage 232d. Therefore, the lubricating oil that is supplied to the axial oil passage 230 is supplied to the high-low switching mechanism 48 via the radial oil passage 232a, and is also supplied to the front-wheel drive clutch 50 via the radial oil passage 232d. Because lubricating oil is supplied to the high-low switching mechanism 48 and the front-wheel drive clutch 50 from one radial oil passage 232a and 232d each in this way, the amounts of lubricating oil that is supplied to the high-low switching mechanism 48 and the front-wheel drive clutch 50 are less. This coincides with the required lubricating oil amounts of the high-low switching mechanism 48 and the front-wheel drive clutch 50 in H4L shown in FIG. 5.

Also, in L4L that is a 4WD running mode in which the high-low switching mechanism 48 is switched to the low-speed rotation L and the front-wheel drive clutch 50 is released, the lubricating sleeve 240 is moved farther toward the side opposite the input shaft 42 (the right side in FIG. 7) in the axial direction than the position of H2, in conjunction with the nut member 94. At this time, the lubricating sleeve 240 is moved to a position where the high-low switching mechanism lubricating hole 260 overlaps with the radial oil passage 232a and the radial oil passage 232b, and the clutch lubricating hole 262 overlaps with the radial oil passage 232e. Therefore, the lubricating oil that is supplied to the axial oil passage 230 is supplied to the high-low switching mechanism 48 via the radial oil passages 232a and 232b, and is also supplied to the front-wheel drive clutch 50 via the radial oil passage 232e. Because lubricating oil is supplied to the front-wheel drive clutch 50 from the single radial oil passage 232e, while lubricating oil is supplied to the high-low switching mechanism 48 from the two radial oil passages 232a and 232b in this way, the amount of lubricating oil that is supplied to the high-low switching mechanism 48 increases, and the amount of lubricating oil that is supplied to the front-wheel drive clutch 50 decreases. That is, the amount of lubricating oil supplied to the high-low switching mechanism 48 increases compared to other running modes. This coincides with the required lubricating oil amounts of the high-low switching mechanism 48 and the front-wheel drive clutch 50 in L4L shown in FIG. 5.

In this way, the lubricating sleeve 240 is moved in conjunction with the nut member 94 that switches the running mode, and the number of oil passages, of the radial oil passages 232a, 232b, 232d, and 232e, that are communicated with the axial oil passage 230, (i.e., the communication state) is switched by the lubricating sleeve 240. Also, the required lubricating oil amounts for the high-low switching mechanism 48 and the front-wheel drive clutch 50 change according to each running mode as shown in FIG. 5, so lubricating oil of amounts according to each running mode is supplied by the lubricating sleeve 240. In this way, the lubricating oil of the axial oil passage 230 is appropriately distributed to the high-low switching mechanism 48 and the front-wheel drive clutch 50, so the oil pump 220 is also prevented from being large in order to ensure that lubricating oil is supplied to the high-low switching mechanism 48 and the front-wheel drive clutch 50. Further, in the running mode of H2, for example, an excessive amount of lubricating oil is supplied to the front-wheel drive clutch 50, so a decrease in fuel efficiency due to drag torque occurring in the friction engagement element 80 is also inhibited.

In this way, according to this example embodiment, the communication state of the axial oil passage 230 and the radial oil passages 232a, 232b, 232d, and 232e is switched according to the position of the lubricating sleeve 240, such that the lubricating oil amounts supplied to the high-low switching mechanism 48 and the front-wheel drive clutch 50 are adjusted, by moving the lubricating sleeve 240 inside the axial oil passage 230. Moreover, the lubricating sleeve 240 moves in conjunction with the nut member 94, so the lubricating oil amounts that are supplied to the high-low switching mechanism 48 and the front-wheel drive clutch 50 are able to be adjusted according to the operating states of the high-low switching mechanism 48 and the front-wheel drive clutch 50, i.e., the running mode. Being able to adjust the lubricating oil amounts supplied to the high-low switching mechanism 48 and the front-wheel drive clutch 50 according to the running mode in this way enables the size of the oil pump 220 to be smaller than when the lubricating oil amounts supplied to the high-low switching mechanism 48 and the front-wheel drive clutch 50 are unable to be adjusted.

Also, according to this example embodiment, the number of radial oil passages 232 that are communicated with the axial oil passage 230 is adjusted according to the position of the lubricating sleeve 240, so the lubricating oil amounts supplied to the high-low switching mechanism 48 and the differential locking mechanism 58 are able to be adjusted.

Moreover, according to this example embodiment, in the running mode corresponding to H4, the transfer torque of the front-wheel drive clutch 50 is adjusted, so the required lubricating oil amount of the front-wheel drive clutch 50 increases, and the amount of lubricating oil supplied to the front-wheel drive clutch 50 increases in response to this, so the front-wheel drive clutch 50 is suitably lubricated. Also, in the running mode corresponding to L4L, torque is transmitted to the planetary gear set 60, so the required lubricating oil amount of the high-low switching mechanism 48 increases, and the lubricating oil amount to the high-low switching mechanism 48 increases in response to this, so the high-low switching mechanism 48 is suitably lubricated.

Next, another example embodiment of the present disclosure will be described. In the description below, portions common to portions in the example embodiment described above will be denoted by like reference characters and descriptions of these portions will be omitted.

In the example embodiment described above, the number of radial oil passages 232a, 232b, 232d, and 232e that are communicated with the axial oil passage 230 is changed according to the running mode by the lubricating sleeve 240, but in this example embodiment, the amounts of lubricating oil supplied to the high-low switching mechanism 48 and the front-wheel drive clutch 50 are adjusted by changing the communicating area of the axial oil passage and the radial oil passages.

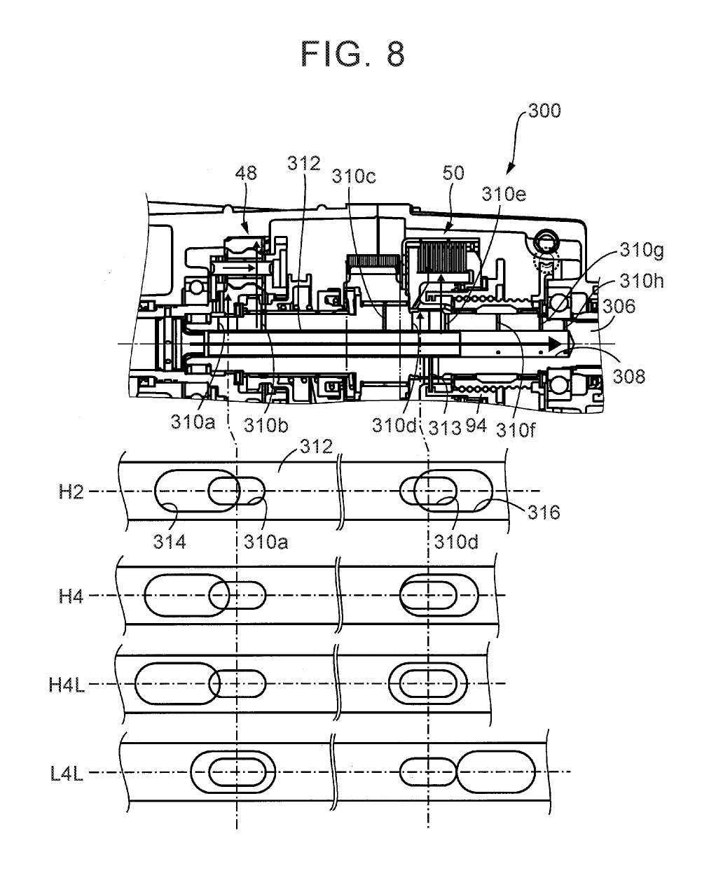

FIG. 8 is a portion of a sectional view of a vehicle transfer 300 according to another example embodiment of the present disclosure, and is also a view illustrating the lubricating structure of the high-low switching mechanism 48 and the front-wheel drive clutch 50 (corresponding to FIG. 7 of the example embodiment described above). An axial oil passage 308 (the axial oil passage 230 in the example embodiment described above) that is parallel to the axis C1 is formed in a rear-wheel side output shaft 306 of this example embodiment (the rear-wheel side output shaft 44 in the example embodiment described above). Moreover, a plurality of radial oil passages 310a to 310h (the radial oil passages 232a to 232h in the example embodiment described above) that are communicated with the axial oil passage 308 are formed in the rear-wheel side output shaft 306. The rear-wheel side output shaft 306 corresponds to the first output rotating member of the present disclosure.

A lubricating sleeve 312 (the lubricating sleeve 240 in the example embodiment described above) that is able to slide along the axis C1 is arranged inside the axial oil passage 308. A pin 313 that extends in the radial direction is fixed to the lubricating sleeve 312. This pin 313 is able to move in the axial direction in conjunction with the nut member 94 by engaging with the nut member 94.

Also, a high-low switching mechanism lubricating hole 314 and a clutch lubricating hole 316 are formed in the lubricating sleeve 312. The high-low switching mechanism lubricating hole 314 and the clutch lubricating hole 316 are formed in the same phase in the circumferential direction, which is a phase apart from the pin 313 in the circumferential direction.

Here, as shown in the lower part of FIG. 8, the radial oil passage 310a formed near the high-low switching mechanism 48 and the radial oil passage 310d formed near the front-wheel drive clutch 50 are each formed elongated in the axial direction.

With this kind of structure, as shown in the lower part of FIG. 8, in the running mode of H2 that is a 2WD running mode, the high-low switching mechanism lubricating hole 314 partially overlaps with the radial oil passage 310a. Also, the clutch lubricating hole 316 partially overlaps with the radial oil passage 310d. The area of these overlapping portions is the communicating area of the axial oil passage 308 and the radial oil passages 310. Therefore, lubricating oil is supplied to the high-low switching mechanism 48 from the portion of the radial oil passage 310a that overlaps with the high-low switching mechanism lubricating hole 314. Also, lubricating oil is supplied to the front-wheel drive clutch 50 from the portion of the radial oil passage 310d that overlaps with the clutch lubricating hole 316. Because the radial oil passages 310a and 310d and the axial oil passage 308 both only partially overlap in this way, the communicating area of the radial oil passages 310a and 310d and the axial oil passage 308 is smaller, so the lubricating oil amounts supplied to the high-low switching mechanism 48 and the front-wheel drive clutch 50 decrease. Also, as shown in FIG. 5 of the example embodiment described above, in the running mode of H2, the required lubricating oil amounts of the high-low switching mechanism 48 and the front-wheel drive clutch 50 are less, and coincide with the required lubricating oil amounts in FIG. 5 because the communicating area of the radial oil passages 310a and 310d and the axial oil passage 308 is reduced by the lubricating sleeve 312.

Also, in the running mode of H4, the high-low switching mechanism lubricating hole 314 partially overlaps with the radial oil passage 310a. On the other hand, the entire radial oil passage 310d overlaps with the clutch lubricating hole 316. Therefore, lubricating oil is supplied to the high-low switching mechanism 48 from the portion where the clutch lubricating hole 316 and the radial oil passage 310a overlap, so the communicating area of the radial oil passage 310a and the axial oil passage 308 is also smaller, and consequently, the amount of lubricating oil supplied to the high-low switching mechanism 48 also decreases. On the other hand, the entire radial oil passage 310d overlaps with the clutch lubricating hole 316, so the communicating area of the radial oil passage 310d with the axial oil passage 308 is the maximum, and consequently, the amount of lubricating oil supplied to the front-wheel drive clutch 50 through the radial oil passage 310d increases. In this way, in the running mode of H4, the amount of lubricating oil supplied to the high-low switching mechanism 48 decreases, and the amount of lubricating oil supplied to the front-wheel drive clutch 50 increases. Also, as shown in FIG. 5 of the example embodiment described above, in the running mode of H4, the required lubricating oil amount of the high-low switching mechanism 48 is small and the required lubricating oil amount of the front-wheel drive clutch 50 is large, but the lubricating sleeve 312 reduces the communicating area of the radial oil passage 310a and increases the communicating area of the radial oil passage 310d, so the required lubricating oil amounts coincide with those in FIG. 5.

Also, in the running mode of H4L, the high-low switching mechanism lubricating hole 314 partially overlaps with the radial oil passage 310a. On the other hand, the entire radial oil passage 310d overlaps with the clutch lubricating hole 316. Therefore, the communicating area of the high-low switching mechanism lubricating hole 314 and the radial oil passage 310a is small, so the amount of lubricating oil supplied to the high-low switching mechanism 48 is small. On the other hand, the entire radial oil passage 310d overlaps with the clutch lubricating hole 316, so the communicating area of the radial oil passage 310d and the axial oil passage 308 is the maximum, and consequently, the amount of lubricating oil supplied to the front-wheel drive clutch 50 through the radial oil passage 310d increases. In this way, in the running mode of H4L, the amount of lubricating oil supplied to the high-low switching mechanism 48 decreases, and the amount of lubricating oil supplied to the front-wheel drive clutch 50 increases. Also, as shown in FIG. 5 of the example embodiment described above, in the running mode of H4L, the required lubricating oil amounts of the high-low switching mechanism 48 and the front-wheel drive clutch 50 are both small, but in this example embodiment, the amount of lubricating oil supplied to the high-low switching mechanism 48 decreases, even though the amount of lubricating oil supplied to the front-wheel drive clutch 50 increases. That is, for the high-low switching mechanism 48, the required lubricating oil amount coincides with that shown in FIG. 5. In the H4L position, the front-wheel drive clutch 50 is in a firmly connected (completely engaged) state, so drag torque will not occur even if the amount of lubricating oil increases.

Also, in the running mode of L4L, the high-low switching mechanism lubricating hole 314 and the radial oil passage 310a completely overlap. On the other hand, the clutch lubricating hole 316 and the radial oil passage 310d do not overlap. Therefore, the communicating area of the high-low switching mechanism lubricating hole 314 and the radial oil passage 310a is the maximum, so the amount of lubricating oil supplied to the high-low switching mechanism 48 through the radial oil passage 310a increases. On the other hand, the radial oil passage 310d does not overlap with the clutch lubricating hole 316, so lubricating oil is not supplied from the radial oil passage 310d. In this way, in the running mode of L4L, the amount of lubricating oil supplied to the high-low switching mechanism 48 increases, and the amount of lubricating oil supplied to the front-wheel drive clutch 50 decreases. Also, as shown in FIG. 5 of the example embodiment described above, in the running mode of L4L, the required lubricating oil amount of the high-low switching mechanism 48 is large and the required lubricating oil amount of the front-wheel drive clutch 50 is small. The lubricating sleeve 312 increases the communicating area of the radial oil passage 310a and reduces the communicating area of the radial oil passage 310d, so the required lubricating oil amount coincides with that shown in FIG. 5.

As described above, according to this example embodiment, the communicating area of the radial oil passages 310a and 310d and the axial oil passage 308 is changed according to the running mode by the lubricating sleeve 312, and an appropriate amounts of lubricating oil are supplied to the high-low switching mechanism 48 and the front-wheel drive clutch 50 according to the running mode, so a similar effect as that of the example embodiment described above is able to be obtained.

While example embodiments of the present disclosure have been described in detail with reference to the drawings, the present disclosure may also be applied in other modes.

For example, in the example embodiments described above, the vehicle 10 is an FR-based four-wheel drive vehicle, but the present disclosure is not limited to an FR-based four-wheel drive vehicle and may also be applied to a FF (front engine front wheel drive)-based four-wheel drive vehicle, for example.

Also, in the example embodiments described above, the front wheel differential gear unit 28 has the front-side clutch 36 provided on the front wheel axle 32R side, so when running in 2WD, rotational power is not transmitted to the rotating elements that form the power transmitting path from the drive gear 46 to the front wheel differential gear unit 28 from either the engine 12 side or the front wheel 14 side. These rotating elements are stopped from rotating, and thus prevented from being dragged along. However, the present disclosure may also be applied to a four-wheel drive vehicle that does not include the front-side clutch 36, and does not stop the rotating elements from rotating when running in 2WD.

Also, in the example embodiments described above, the number of radial oil passages that are communicated with the axial oil passage, or the communicating area of the axial oil passage and the radial oil passages, is switched by the lubricating sleeve, but both of these may also be switched.

Also, in the example embodiments described above, when the high-low switching mechanism 48 switches to the low-speed rotation L, torque is transmitted to the front wheel 14 side by the differential locking mechanism 58, but torque may also be transmitted to the front wheel 14 side by firmly connecting (completely engaging) the front-wheel drive clutch 50.

Moreover, in the example embodiments described above, the screw mechanism 86 includes the balls 96, but the balls 96 may also be omitted.

Also, in the example embodiments described above, the front-wheel drive clutch 50 is a wet type multiple disc clutch, but this specification is not limited to a wet type multiple disc clutch and may also be applied to a wet type single disc clutch.

The example embodiments described above are no more than example embodiments. That is, the present disclosure may be carried out in modes that have been modified or improved in any of a variety of ways based on the knowledge of one skilled in the art.

1. A vehicle transfer comprising:
an input rotating member configured to rotate around an axis;
a first output rotating member configured to output power to first left and right wheels of the vehicle;
a second output rotating member configured to output power to second left and right wheels of the vehicle;
a high-low switching mechanism configured to change a rate of rotation input from the input rotating member and transmit a resultant rotation to the first output rotating member;
a clutch configured to transmit a portion of torque from the first output rotating member to the second output rotating member, the clutch being a wet type clutch;
an oil pump configured to supply lubricating oil to the high-low switching mechanism and the clutch;
an oil passage formed in the first output rotating member, the oil passage including an axial oil passage that extends in an axial direction of the first output rotating member and a plurality of radial oil passages that extend in a radial direction of the first output rotating member, such that lubricating oil delivered from the oil pump is supplied to the high-low switching mechanism and the clutch;
a transmitting mechanism that includes an electric motor, and a screw mechanism that converts rotational motion of the electric motor to linear motion, the transmitting mechanism configured to transmit the linear motion of the screw mechanism to both the high-low switching mechanism and the clutch; and
a lubricating sleeve arranged in the axial oil passage, the lubricating sleeve configured to move inside the axial oil passage in conjunction with the linear motion of the screw mechanism, the lubricating sleeve configured to switch a communication state of the axial oil passage and the plurality of radial oil passages according to a position of the lubricating sleeve inside the axial oil passage, such that amounts of the lubricating oil supplied to the high-low switching mechanism and the clutch are adjusted.

2. The vehicle transfer according to claim 1, wherein the lubricating sleeve is configured to adjust the number of the plurality of radial oil passages that are communicated with the axial oil passage, according to the position of the lubricating sleeve inside the axial oil passage.

3. The vehicle transfer according to claim 1, wherein the lubricating sleeve is configured to adjust a communicating area of the axial oil passage and the radial oil passages, according to the position of the lubricating sleeve inside the axial oil passage.

4. The vehicle transfer according to claim 1, wherein
the high-low switching mechanism includes a planetary gear set, the high-low switching mechanism is configured to switch to one of a high-speed rotation and a low-speed rotation, the high-low switching mechanism is configured such that the planetary gear set rotates idly when the high-low switching mechanism is switched to the high-speed rotation, and the high-low switching mechanism is configured such that torque is transmitted to the planetary gear set when the high-low switching mechanism is switched to the low-speed rotation;
the transmitting mechanism is configured to transmit the linear motion of the screw mechanism to the high-low switching mechanism and the clutch such that the high-low switching mechanism and the clutch switch to at least three running modes including a two-wheel drive running mode, a first four-wheel drive running mode, and a second four-wheel drive running mode,
in the two-wheel drive running mode, the high-low switching mechanism is switched to the high-speed rotation and the clutch is released,
in the first four-wheel drive running mode, the high-low switching mechanism is switched to the high-speed rotation and transfer torque of the clutch is adjusted, and
in the second four-wheel drive running mode, the high-low switching mechanism is switched to the low-speed rotation and torque from the input rotating member is transmitted to the second output rotating member; and
the lubricating sleeve is configured to switch the communication state of the axial oil passage and the plurality of radial oil passages according to the position of the lubricating sleeve inside the axial oil passage, such that in the first four-wheel drive running mode, the amount of lubricating oil supplied to the clutch increases, and in the second four-wheel drive running mode, the amount of lubricating oil supplied to the high-low switching mechanism increases.
